(19) United States
(12) Patent Application Publication
(10) Pub. No.: US 2020/0351423 A1
(43) Pub. Date: Nov. 5, 2020

(54) LIGHT SHIELD, LENS MODULE, AND IMAGING LENS USING THE SAME

(71) Applicant: HON HAI PRECISION INDUSTRY CO., LTD., New Taipei (TW)

(72) Inventors: YU-CHIAO HUANG, New Taipei (TW); CHUN-CHENG KO, New Taipei (TW)

(21) Appl. No.: 16/858,957

(22) Filed: Apr. 27, 2020

(30) Foreign Application Priority Data
Apr. 30, 2019 (CN) 201910360744.7

(51) Int. Cl. H04N 5/225; G02B 13/18; G02B 27/00

(52) U.S. Cl. CPC H04N 5/2254; G02B 27/0037; G02B 13/18

(57) ABSTRACT

A light shield for reducing the amount of stray light reaching an image sensor includes a first surface, a second surface, an outer lateral face, and an inner lateral face. The first surface faces an object side and defines a first central opening. The second surface faces an image side and defines a second central opening communicating with the first central opening. The outer lateral face connects outer side edges of the first and second surfaces. The inner lateral face connects inner side edges of the first and second surface surfaces. A first intersection angle is defined between the second surface and a contour line of the inner lateral face connecting the first surface and the second surface, and the first intersection angle is a sharp corner.

### FIELD

The subject matter herein generally relates to imaging, in particular to a light shield, a lens module including the light shield, and an imaging lens including the lens module.

### BACKGROUND

When a conventional imaging lens is used, light of a specific intersection angle can reach an inner wall of a lens barrel, and then is reflected and scattered by the lens barrel as stray light. For example, FIGS. 1 and 2 illustrate an imaging lens 300, when the imaging lens 300 is used, light of a specific intersection angle can reach an inner wall of a lens barrel. Because of a rounded corner A3 in an inner hole of a light through hole between the inner wall of the lens barrel and a lens assembly, the light is easily scattered by the rounded corner A3 to be stray light to the lens assembly, which affects an image quality of the imaging lens.

### BRIEF DESCRIPTION OF THE DRAWINGS

Implementations of the present technology will now be described, by way of embodiment, with reference to the attached figures.

FIG. 1 is an isometric view of a traditional imaging lens in which a light path is shown.

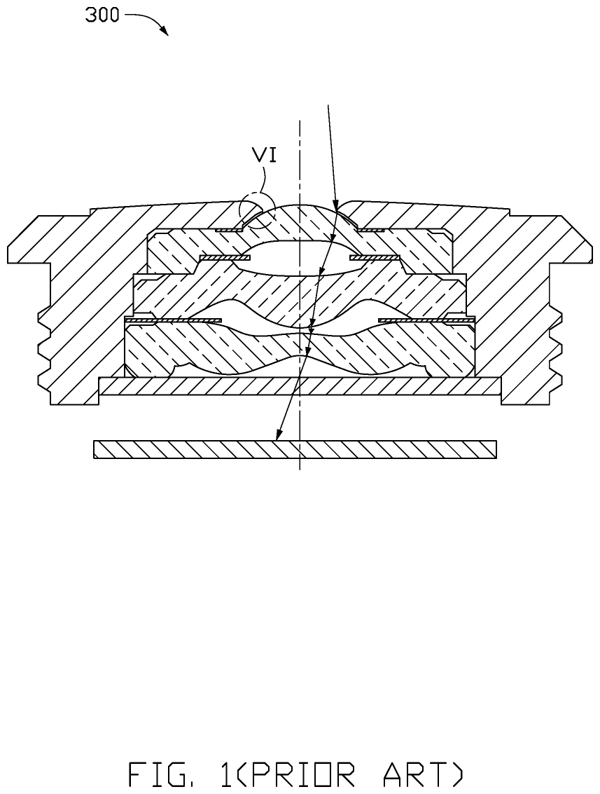

FIG. 2 is an enlarged view of circle area VI of FIG. 1.

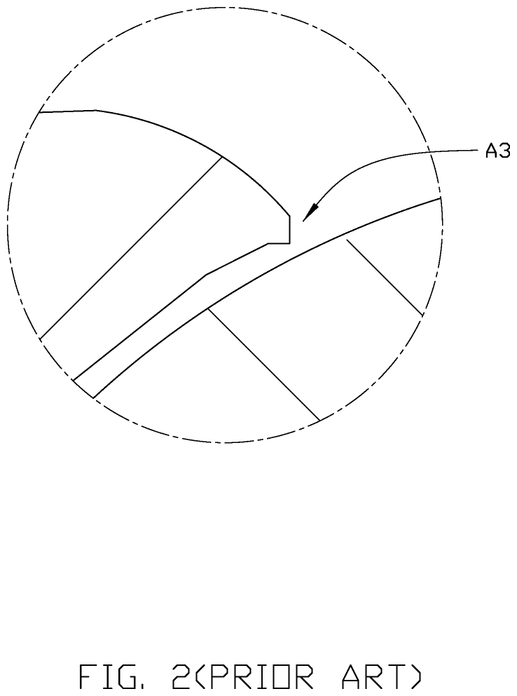

FIG. 3 is an isometric view of an embodiment of a light shield.

FIG. 4 is a cross-sectional view of the light shield of FIG. 3 disposed in front of a lens.

FIG. 5 is a cross-sectional view of an embodiment of a lens module.

FIG. 6 is a cross-sectional view of an embodiment of an imaging lens.

### DETAILED DESCRIPTION

Implementations of the disclosure will now be described, by way of embodiments only, with reference to the drawings. The disclosure is illustrative only, and changes may be made in the detail within the principles of the present disclosure. It will, therefore, be appreciated that the embodiments may be modified within the scope of the claims.

Terms used herein in the specification of the present disclosure are only for the purpose of describing specific embodiments, and not intended to limit the present disclosure. When one component is considered as “being fixed to” another component, the one component may be fixed directly to the other component or an intermediate component might be present simultaneously. When one component is considered as “being connected to” another component, the one component may be connected directly to the other component or an intermediate component might be present simultaneously. When a component is referred to as “being disposed on” another component, the component may be disposed on the other component or an intermediate component might be present simultaneously.

Unless otherwise defined, all technical terms used herein have the same meaning as commonly understood by one of ordinary skill in the art. The technical terms used herein are to provide a thorough understanding of the embodiments described herein, but are not to be considered as limiting the scope of the embodiments.

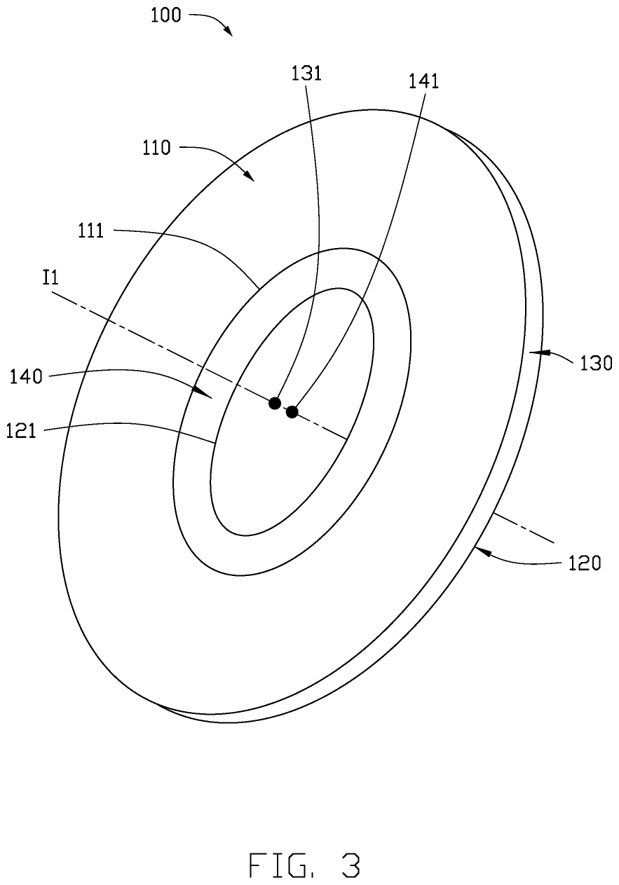

FIG. 3 illustrates an embodiment of a light shield (light shield 100) which includes a first surface 110, a second surface 120, an outer lateral face 130, and an inner lateral face 140. The first surface 110 faces the object side, that is the first surface 110 faces light incoming from a source. The first surface 110 is the front side of the light shield 100. The first surface 110 has a first central opening 111 which is substantially rounded.

The second surface 120 faces the image side, that is the second surface 120 faces an image sensor. The second surface 120 is the back side of the light shield 100. The second surface 120 has a second central opening 121 which is substantially rounded and communicating with the first central opening 111. The second surface 120 is opposite to and parallel to the first surface 110. In the present embodiment, a center axis I1 of the light shield 100 passes through a center point 131 of the first central opening 11 and a center point 141 of the second central opening 121.

The outer lateral face 130 connects the outer side edges of the first surface 110 and the second surface 120. The inner lateral face 140 connects the inner side edges of the first surface 110 and the second surface 120. That is, the inner lateral face 140 connects the first central opening 111 and the second central opening 121.

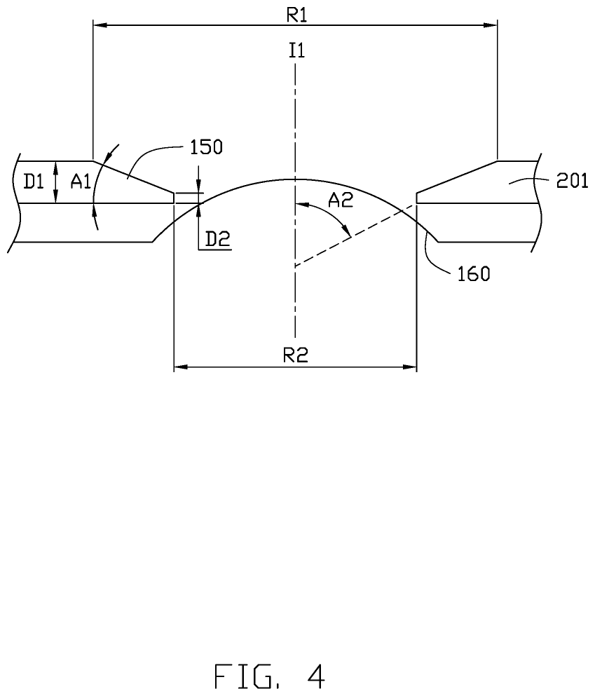

FIG. 4 illustrates that the light shield 100 is disposed in front of a lens 160. The lens 160 can be any lens. The first central opening 111 has a diameter of R1, the second central opening 121 has a diameter of R2, wherein the diameter R1 is greater than the diameter R2. In the present embodiment, the diameter R1 is about 0.58 mm, the diameter R2 is about 0.49 mm. The front and back sides of the light shield 100 can be seen by observing the diameters R1 and R2 of central openings on opposite surfaces of the light shield 100, wherein the surface where the central opening having a large diameter is located in the front side of the light shield 100.

A vertical distance D1 between the first surface 110 and the second surface 120 is less than 30 μm. In the present embodiment, the vertical distance D1 is about 25 μm.

The inner lateral face 140 includes a contour line 150 connecting the first surface 110 and the second surface 120. A first intersection angle A1 is defined between the contour line 150 and the second surface 120. The first intersection angle A1 is a sharp corner. When light strikes the first intersection angle A1 via the first central opening 111, the first intersection angle A1 largely prevents light being reflected on to the lens 160, this reduces the generation of stray light, thus the image quality is not reduced.

A vertical distance D2 between a peak of the first intersection angle A1 and the second surface 120 is less than 3 In the present embodiment, the vertical distance D2 is about 1.7 μm.

An intersection angle A2 is defined between the contour line 50 and the center axis I1. In the present embodiment, the second intersection angle A2 is about 61 degrees. Compared to a traditional light shield, since the light shield 100 has the second intersection angle A2 between the contour line 50 and the center axis I1, the light shield 100 prevents the generation of stray light without blocking light for imaging. Therefore, when assembling, it is important to distinguish between the front surface and the back surface of the light shield 100. By providing through holes with different sizes on the first surface 110 and the second surface 120, the correct assembly of the light shield 100 is ensured. The light shield 100 is made of metal or other materials.

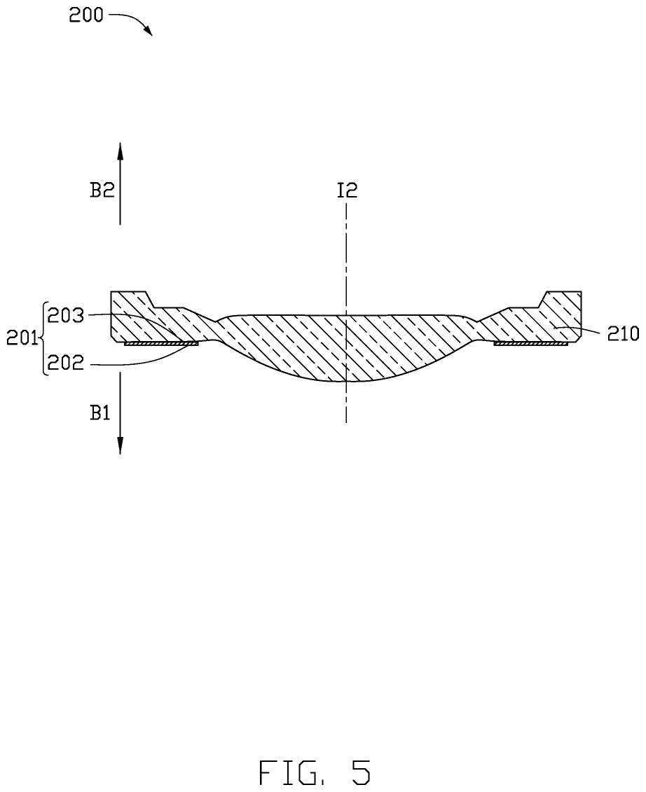

FIG. 5 illustrates a lens module 200 including the light shield 201 and a first lens 210 arranged from the object side B1 to the image side B2. The light shield 201 is disposed in front of a surface of the first lens 210 facing the light source. A light beam from the object side enters into the first lens 210 through the central openings of the light shield 201, and passes through the first lens 210 to the image side B2. The light shield 201 will block unwanted light from entering into the first lens 210. If the light shield is wrongly assembled, the light shield 201 will block the light from entering into the first lens 210. The front side and the back side of the light shield 201 can be accurately distinguished by the diameters of the central openings on opposite surfaces of the light shield 201, which facilitates the correct assembly of the light shield 201.

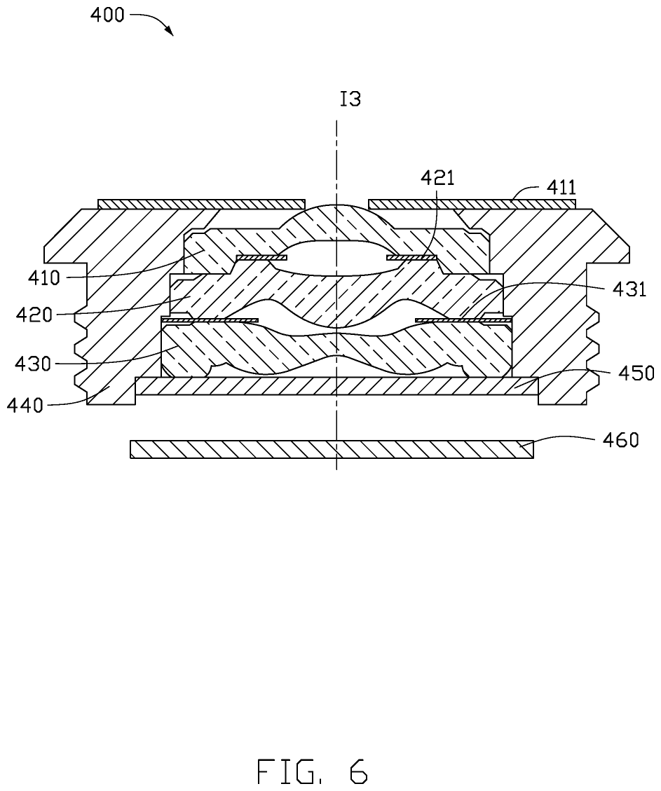

FIG. 6 illustrates an embodiment of an imaging lens 400 including a lens barrel 440, an optical filter 450, a lens module, and an image sensor 460. The lens module includes a first lens 410, a second lens 420, and a third lens 430. The first lens 410, the second lens 420, and the third lens 430 are disposed in the lens barrel 440 in such order from the object side to the image side. The lens module further includes three light shields 411, 421, and 431 respectively disposed in front of the corresponding lens. In detail, the light shield 411 is disposed on the first lens 410, the light shield 421 is disposed between the first lens 410 and the second lens 420, and the light shield 431 is disposed between the second lens 420 and the third lens 430.

The first light shield 411 has a structure similar to that of the above light shield. The light shields 421 and 431 can be an ordinary light shield. The optical filter 450 is disposed on a side of the lens module away from the light source. The image sensor 460 is configured to receive unblocked light emitted from the imaging lens 400. In the imaging lens 400, the light shield 411 can shield against a majority of stray light, and the light shields 421 and 423 add further shielding against stray light, thus the imaging quality is improved.

While the present disclosure has been described with reference to particular embodiments, the description is illustrative of the disclosure and is not to be construed as limiting the disclosure. Therefore, those of ordinary skill in the art can make various modifications to the embodiments without departing from the scope of the disclosure as defined by the appended claims.

What is claimed is:

1. A light shield comprising
a first surface facing an object side and defining a first central opening;
a second surface facing an image side and defining a second central opening communicating with the first central opening;
an outer lateral face connecting outer side edges of the first and second surfaces; and
an inner lateral face connecting inner side edges of the first and second surface surfaces;
wherein a first intersection angle is defined between the second surface and a contour line of the inner lateral face connecting the first surface and the second surface, the first intersection angle is a sharp corner.

2. The light shield of claim 1, wherein a central axis of the first central opening coincides with a central axis of the second central opening.

3. The light shield of claim 1, wherein a second intersection angle is defined between the contour line of the inner lateral face and a central axis of the first central opening.

4. The light shield of claim 1, wherein the first central opening has a diameter greater than a diameter of the second central opening.

5. The light shield of claim 1, wherein a vertical distance between the first surface and the second surface is less than 30 μm.

6. The light shield of claim 5, wherein a vertical distance between a peak of the first intersection angle and the second surface is less than 3 μm.

7. The light shield of claim 1, wherein material of the light shield is metal.

8. A lens module comprising:
a light shield comprising:
a first surface facing an object side and defining a first central opening;
a second surface facing an image side and defining a second central opening communicating with the first central opening;
an outer lateral face connecting outer side edges of the first and second surfaces; and
an inner lateral face connecting inner side edges of the first and second surface surfaces;
wherein a first intersection angle is defined between the second surface and a contour line of the inner lateral face connecting the first surface and the second surface, the first intersection angle is a sharp corner.

9. The lens module of claim 8, further comprising a first lens, wherein the light shield is disposed in front of a surface of the first lens facing a light source.

10. The lens module of claim 8, wherein a central axis of the first central opening coincides with a central axis of the second central opening.

11. The lens module of claim 8, wherein a second intersection angle is defined between the contour line of the inner lateral face and a central axis of the first central opening.

12. The lens module of claim 8, wherein the first central opening has a diameter greater than a diameter of the second central opening.

13. The lens module of claim 8, wherein a vertical distance between the first surface and the second surface is less than 30 μm.

14. The lens module of claim 13, wherein a vertical distance between a peak of the first intersection angle and the second surface is less than 3 μm.

15. An imaging lens comprising a lens module, the lens module comprising:
a light shield comprising:
a first surface facing an object side and defining a first central opening;
a second surface facing an image side and defining a second central opening communicating with the first central opening;
an outer lateral face connecting outer side edges of the first and second surfaces; and
an inner lateral face connecting inner side edges of the first and second surface surfaces;
wherein a first intersection angle is defined between the second surface and a contour line of the inner lateral face connecting the first surface and the second surface, the first intersection angle is a sharp corner.
